(19) United States
(12) Patent Application Publication
(10) Pub. No.: US 2010/0207507 A1
(43) Pub. Date: Aug. 19, 2010

(54) ELECTRODE ASSEMBLY FOR A COLD CATHODE FLUORESCENT LAMP

(76) Inventors: Byung Hyun Kim, Gyeonggi-do (KR); Hun Ham, Gyeonggi-do (KR); Jin Kook Kim, Gyeonggi-do (KR)

Correspondence Address: IPLA P.A., 3550 WILSHIRE BLVD., 17TH FLOOR, LOS ANGELES, CA, 90010, US

(21) Appl. No.: 12/738,966

(22) PCT Filed: May 23, 2008
(86) PCT No.: PCT/KR08/02886

§ 371 Date: Apr. 20, 2010

(30) Foreign Application Priority Data
Oct. 23, 2007 (KR) 10-2007-0106666

(51) Int. Cl. H01J 61/06

(52) U.S. Cl. 313/331

(57) ABSTRACT

The present invention provides an electrode assembly for a cold cathode fluorescent lamp, including: a body connector made of glass; a connecting wire sealingly embedded in the body connector in a manner of penetrating the body connector; an electrode defining an electron emission space therein, the electrode being connected to one end of the connecting wire and being disposed in a glass tube; and an external wire which is connected to the other end of the connecting wire and is disposed outside the glass tube, wherein the connecting wire includes a central part made of a material having high electric conductivity and thermal conductivity, and a circumferential part made of a material having lower electric conductivity and thermal conductivity than those of the material used to make the central part. The present invention is advantageous in that the polarization phenomenon of mercury can be prevented by increasing the temperature of an electrode assembly of a cold cathode fluorescent lamp, the lifespan of the cold cathode fluorescent lamp can be increased by securing a sufficient amount of mercury necessary for an electric discharge, and the uniformity of an emission region can be improved by preventing dark regions from being formed by the polarization phenomenon of mercury.

### TECHNICAL FIELD

The present invention relates to an electrode assembly for a cold cathode fluorescent lamp, and, more particularly, to an electrode assembly for a cold cathode fluorescent lamp, which can emit a large amount of light and has uniform brightness.

### BACKGROUND ART

A cold cathode fluorescent lamp (CCFL) is a fluorescent lamp which is capable of turning on at low temperature without heating a filament. The cold cathode fluorescent lamp includes a glass tube, and electrodes provided in both ends of the glass tube. The glass tube is filled with a gas mixture of mercury (Hg), argon (Ag) and neon (Ne). Like a general fluorescent lamp, the glass tube is coated on the inner surface thereof with a fluorescent material. In a general fluorescent lamp, electrons are emitted by heating a filament, but, in the cold cathode fluorescent lamp, electrons are emitted by a high-voltage electric field applied between two electrodes. When electrons begin to be emitted, mercury is excited to generate ultraviolet rays, and the ultraviolet rays collide with the fluorescent material applied on the inner surface of the glass tube to generate visible rays. The cold cathode fluorescent lamp is practically used in LCD displays, facsimiles, scanners, copiers, decorative light sources, and the like.

Since the cold cathode fluorescent lamp needs a voltage of several hundreds to several thousands volts, it turns on by an inverter. The cold cathode fluorescent lamp is driven at a high frequency of 20 KHz or more to convert a low direct voltage into a high alternating voltage, and thus the cold cathode fluorescent lamp begins to emit light.

The cold cathode fluorescent lamp is provided in both ends thereof with electrode assemblies, and the electrode assemblies emit electrons. However, the cold cathode fluorescent lamp is problematic in that, when the cold cathode fluorescent lamp is not activated, mercury is polarized onto the both ends of the cold cathode fluorescent lamp, thus forming dark regions on both ends thereof.

### DISCLOSURE OF INVENTION

### Technical Problem

Accordingly, the present invention has been made keeping in mind the above problems occurring in the prior art, and an object of the present invention is to provide an electrode assembly for a cold cathode fluorescent lamp, which can prevent dark regions from being formed on both ends of a cold cathode fluorescent lamp by inhibiting the polarization phenomenon of mercury.

### Technical Solution

In order to accomplish the above object, an aspect of the present invention provides an electrode assembly for a cold cathode fluorescent lamp, including: a body connector made of glass; a connecting wire sealingly embedded in the body connector in a manner of penetrating the body connector; an electrode defining an electron emission space therein, the electrode being connected to one end of the connecting wire and being disposed in a glass tube; and an external wire which is connected to the other end of the connecting wire and is disposed outside the glass tube, wherein the connecting wire includes a central part made of a material having high electric conductivity and thermal conductivity, and a circumferential part made of a material having lower electric conductivity and thermal conductivity than those of the material used to make the central part.

### ADVANTAGEOUS EFFECTS

The present invention is advantageous in that the polarization phenomenon of mercury can be prevented by increasing the temperature of an electrode assembly of a cold cathode fluorescent lamp, the lifespan of the cold cathode fluorescent lamp can be increased by securing a sufficient amount of mercury necessary for an electric discharge, and the uniformity of an emission region can be improved by preventing dark regions from being formed by the polarization phenomenon of mercury.

### BRIEF DESCRIPTION OF THE DRAWINGS

FIG. 1 is a sectional view showing a cold cathode fluorescent lamp including an electrode assembly according to an embodiment of the present invention;

FIG. 2 is an enlarged sectional view showing the electrode assembly shown in FIG. 1 according to an embodiment of the present invention;

FIG. 3 is a sectional view showing a connecting wire taken along the line A-A in FIG. 2; and

FIG. 4 is a graph showing the temperature characteristics of a cold cathode fluorescent lamp of the present invention and a conventional cold cathode fluorescent lamp.

### DESCRIPTION OF THE ELEMENTS IN THE DRAWINGS

100: cold cathode fluorescent lamp

100a: internal space

110: glass tube

110a: fluorescent material

120: electrode assembly

121: body connector

122: connecting wire

123: electrode

124: external wire

### BEST MODE FOR CARRYING OUT THE INVENTION

Hereinafter, preferred embodiments of the present invention will be described in detail with reference to the accompanying drawings.

However, the following embodiments of the present invention may be variously modified, and the scope and spirit of the present invention is not limited thereto. Embodiments of the present invention are provided in order to concretely explain the present invention to those skilled in the art.

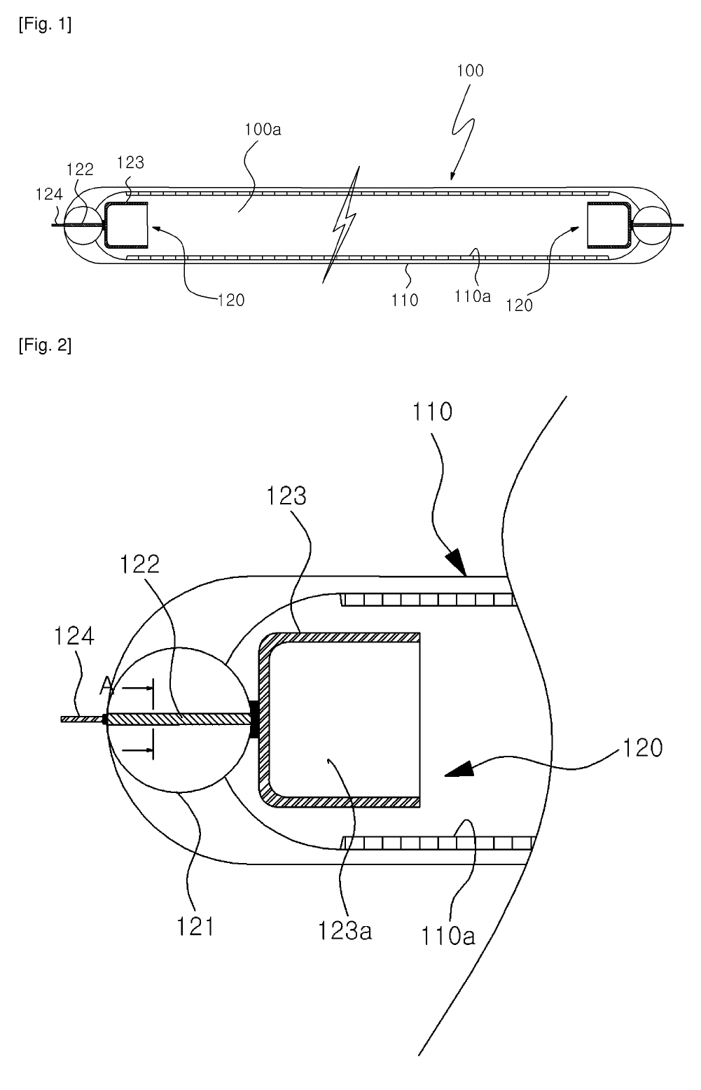

FIG. 1 is a sectional view showing a cold cathode fluorescent lamp including an electrode assembly according to an embodiment of the present invention.

The cold cathode fluorescent lamp includes a glass tube 110 which is coated on the inner surface thereof with a fluorescent material 110a, a pair of electrode assemblies 120 which is provided in both ends of the glass tube 110 to seal the glass tube 110, and a gas mixture which is charged in an internal space 100a formed by the glass tube 110 and the pair of electrode assemblies 120.

The pair of electrode assemblies 120 emits electrons, and the emitted electrons excite mercury included in the gas mixture charged in the internal space 100a to generate ultraviolet rays. At this time, the generated ultraviolet rays collide with the fluorescent material applied on the inner surface of the glass tube 110 to emit light. The gas mixture includes mercury (Hg), argon (Ag) and neon (Ne).

FIG. 2 is an enlarged sectional view showing the electrode assembly shown in FIG. 1 according to an embodiment of the present invention.

The electrode assembly 120 includes a body connector 121 made of glass, a connecting wire 122 sealingly embedded in the body connector 121 in a manner of penetrating the body connector 121, an electrode 123 defining an electron emission space 123a therein, which is connected to one end of the connecting wire 122 and is disposed in the glass tube 110, and an external wire 124 which is connected to the other end of the connecting wire and is disposed outside the glass tube 110.

The connecting wire 122 includes a central part and a circumferential part, which are made of different materials. The central part has electrical characteristics, and the circumferential part has expansion characteristics. Due to the combination of such characteristics of the connecting wire 122, the cold cathode fluorescent lamp of the present invention may have good characteristics.

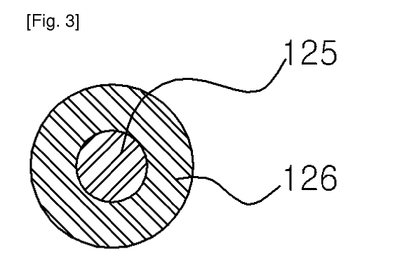

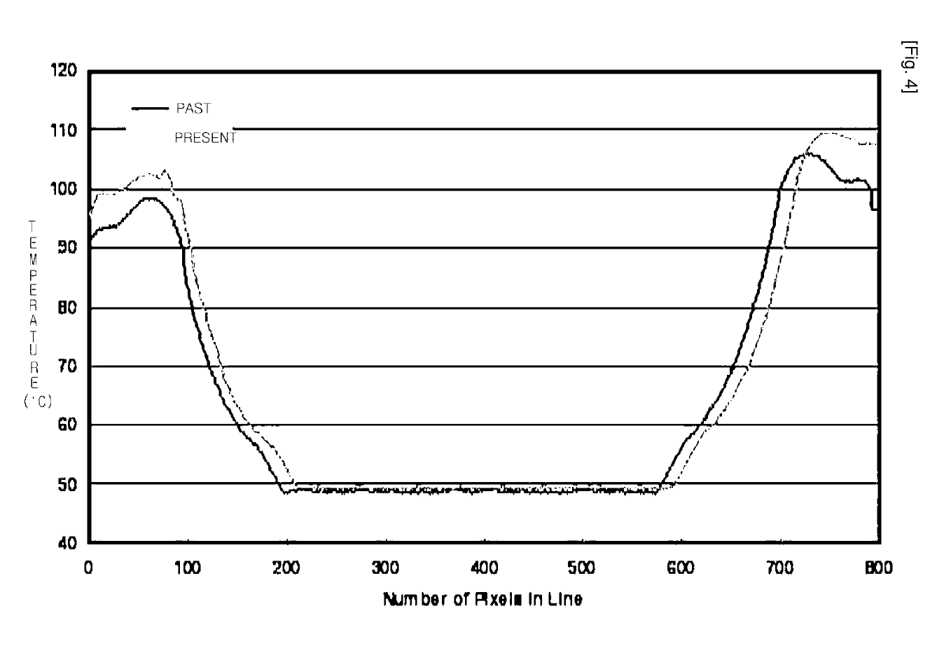

FIG. 3 is a sectional view showing the connecting wire taken along the line A-A in FIG. 2.

As shown in FIG. 3, the connecting wire 122 includes the central part 125 and the circumferential part 126. The central part 125 of the connecting wire 122 is made of a material having high electric conductivity and thermal conductivity, and the circumferential part 126 of the connecting wire 122 is made of a material having lower electric conductivity and thermal conductivity than those of the central port 125. Further, the circumferential part 126 of the connecting wire 122 is made of a material having a composition corresponding to an expansion coefficient of soft glass. Examples of the material having a low expansion coefficient may include nickel(Ni)-iron(Fe) alloy, cobalt (Co), and molybdenum (Mo). The circumferential part 126 of the connecting wire 122 is made of a material having a composition corresponding to an expansion coefficient of soft glass, and thus the connecting wire 122 is safely combined with the body connector 121 formed by fusion-bonding the glass tube 110.

According to an embodiment of the present invention, the central part 125 of the connecting wire 122 is made of copper (Cu), and the circumferential part of the connecting wire 122 is made of nickel(Ni)-iron(Fe) alloy.

In the embodiment of the present invention, the area of the central part 125 made of copper is 5˜70% of the total area of the connecting 122, and the circumferential part 126 is made of nickel(Ni)-iron(Fe) alloy having a thermal expansion coefficient of 70˜120*10⁻⁷ corresponding to that of soft glass. Since the circumferential part 126 has the same thermal expansion coefficient as that of soft glass, the glass tube 110 is not influenced by the expansion of the connecting wire 122 attributable to temperature change.

Further, since the central part 125 of the connecting wire 122 is made of copper, the electric conductivity of the connecting wire 122 is increased, so that a large amount of electricity is supplied to the electrode 123, thereby increasing the electron emission efficiency of the electrode 123. When the electron emission efficiency of the electrode 123 is increased, the temperature of the cold cathode fluorescent lamp is increased. Since the electron emission efficiency of the electrode 123 is also increased with the increase in the temperature of the cold cathode fluorescent lamp, the electrons emitted from the electrode 123 excite mercury present in the glass tube 110 to generate a larger amount of ultraviolet rays, so that the generated ultraviolet rays more frequently collide with the fluorescent material 110a present in the glass tube 110, thereby increasing the luminance efficiency of the cold cathode fluorescent lamp. Further, when the electron emission efficiency of the electrode 123 is increased, the electrons emitted from the electrode 123 increasingly collide with the mercury present in the glass tube 110, the mercury moves to the central portion of the glass tube 110.

FIG. 4 is a graph showing the temperature characteristics of a cold cathode fluorescent lamp of the present invention and a conventional cold cathode fluorescent lamp.

As shown in FIG. 4, comparing the temperature characteristics of the cold cathode fluorescent of the present invention with those of the conventional cold cathode fluorescent lamp, it can be seen that the temperature near the electrode assemblies 120 in the cold cathode fluorescent lamp of the present invention is relatively high, and thus the cold cathode fluorescent lamp exhibits various good characteristics.

In words, since the central part 125 of the connecting wire 122 for supplying electricity to the electrode assembly 120 has higher electric conductivity than that of the conventional connecting wire, a relatively large amount of electricity is supplied to the electrode 123. When a relatively large amount of electricity is supplied to the electrode 123 through the connecting wire 122, the electron emission efficiency of the electrode 123 can be increased. When the electron emission efficiency of the electrode 123 is increased, the temperature of the electrode assembly 120 is relatively increased, thus maintaining its temperature high during the operation of the cold cathode fluorescent lamp.

Referring to the temperature characteristics of the cold cathode fluorescent lamp of the present invention, shown in FIG. 4, when the temperature of the electrode assembly 120 of the cold cathode fluorescent lamp of the present invention is maintained high, compared to that of the conventional cathode fluorescent lamp, mercury charged in the internal space 100a of the glass tube 110 is positioned at the center of the cold cathode fluorescent lamp. The reason why mercury is positioned at the center of the cold cathode fluorescent lamp is that mercury is moved to the center of the glass tube 110 by a convection phenomenon.

When mercury moves to the center of the glass tube 110, the phenomenon in which mercury is polarized to both ends of the cold cathode fluorescent lamp is prevented, so that a sufficient amount of mercury necessary for electric discharge is secured, thereby increasing the lifespan of the cold cathode fluorescent lamp. Particularly, in the case of a backlight unit, the formation of dark regions at both ends of the cold cathode fluorescent lamp, caused by the polarization phenomenon of mercury in the cold cathode fluorescent lamp, is prevented, thereby improving the brightness uniformity of the backlight unit.

From FIG. 4, it can be seen that, when cold cathode fluorescent lamps turn off, the temperature of both ends of the glass tube 110 of the cold cathode fluorescent lamp according to the present invention is relatively high compared to that of the conventional cold cathode fluorescent lamp. When the temperature of both ends of the glass tube 110 is high, a convection phenomenon occurs, and thus mercury moves to the center of the glass tube 110. When mercury moves to the center of the glass tube 110, the formation of dark regions occurring at both ends of the glass tube 110 is prevented, thus increasing the lifespan of the cold cathode fluorescent lamp.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electrode assembly for a cold cathode fluorescent lamp, comprising:
a body connector made of glass;
a connecting wire sealingly embedded in the body connector in a manner of penetrating the body connector;
an electrode defining an electron emission space therein, the electrode being connected to one end of the connecting wire and being disposed in a glass tube; and
an external wire which is connected to the other end of the connecting wire and is disposed outside the glass tube,
wherein the connecting wire includes a central part made of a material having high electric conductivity and thermal conductivity, and a circumferential part made of a material having lower electric conductivity and thermal conductivity than those of the material used to make the central part.

2. The electrode assembly for a cold cathode fluorescent lamp according to claim 1, wherein the material used to make the central part of the connecting wire is copper (Cu), copper alloy, silver (Ag), or gold (Au).

3. The electrode assembly for a cold cathode fluorescent lamp according to claim 1, wherein the material used to make the circumferential part of the connecting wire is nickel-iron alloy (Ni—Fe alloy), kovar (Fe—Ni—Co alloy), or molybdenum (Mo), or dumet (Ni—Fe alloy coated with Cu).
